(19) United States
(12) Patent Application Publication
(10) Pub. No.: US 2025/0289336 A1
(43) Pub. Date: Sep. 18, 2025

(54) AUXILIARY POWER SYSTEM FOR A SEMI-TRUCK

(71) Applicant: Sean Rees, Pompano Beach, FL (US)

(72) Inventor: Sean Rees, Pompano Beach, FL (US)

(21) Appl. No.: 19/078,895

(22) Filed: Mar. 13, 2025

Related U.S. Application Data
(60) Provisional application No. 63/564,567, filed on Mar. 13, 2024.

(51) Int. Cl. B60L 50/60; B60K 1/04; B60L 7/10; B60L 53/51; B60L 58/16; B60L 58/22

(52) U.S. Cl. CPC B60L 53/51; B60K 1/04; B60L 58/22; B60K 2001/0444; B60L 2200/36; B60L 2240/14; B60L 2240/545

(57) ABSTRACT

An auxiliary power system for an electric semi-truck is disclosed. The auxiliary power system includes a power storage device mounted to a semi-trailer. One or more main batteries provide propulsion to a semi-truck and are in electrical communication with the power storage device to receive auxiliary power therefrom. The power storage device is operable to increase the range over which the semi-truck travels between recharging. The power storage device may be configured to either provide supplemental power to increase the power output of the semi-truck in real-time or may be configured to increase the range between recharging of the main batteries of the semi-truck.

### CROSS-REFERENCE TO RELATED APPLICATIONS

The present application claims priority to U.S. Provisional Patent Application No. 63/564,567 filed Mar. 13, 2024, titled “AUXILIARY POWER SYSTEM FOR A SEMI-TRUCK,” which is hereby incorporated by reference in its entirety.

### TECHNICAL FIELD

The embodiments disclosed herein generally relate to electric vehicle power systems and more specifically to auxiliary power systems for a trailer to power an electric semi-truck that enhances range, efficiency, and energy management.

### BACKGROUND

Electric vehicles utilize one or more electric motors for propulsion which can include collector systems which use electricity from extravehicular sources, or the vehicle may be powered autonomously using a battery or fuel cell. In particular, on-road electric vehicles utilize onboard power storage systems.

A common problem with electric vehicles compared to their gasoline-powered counterparts is the limited range many vehicles are capable of traveling under electric power. This is especially problematic for large trucks used to transport cargo. These vehicles require a large battery which increases weight substantially compared to the weight in fuel needed for similar diesel-powered vehicles. Further, transporting heavy cargo over long distances results in more frequent recharging, and thus, longer shipping times. For this reason, electric semi-trucks are in limited use.

Various approaches have been proposed to address these limitations, including the development of larger battery systems, fast-charging infrastructure, battery swap system, and improvements in battery energy density. However, these solutions often introduce additional complications, such as increased vehicle weight, higher costs, or dependence on specialized infrastructure that may not be widely available.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to an auxiliary power system for an electric semi-truck. The auxiliary power system includes a power storage device mounted to a semi-trailer. One or more main batteries provide propulsion to a semi-truck and are in electrical communication with the power storage device to receive auxiliary power therefrom. The power storage device is operable to increase the range over which the semi-truck travels between recharging. The power storage device may be configured to either provide supplemental power to increase the power output of the semi-truck in real-time or may be configured to increase the range between recharging of the main batteries of the semi-truck.

The auxiliary power system provides multiple functionalities depending on its configuration. In one configuration, the auxiliary power system may be used to significantly increase the power output capabilities of the semi-truck. This may be selectively controlled by an operator to provide an on-demand increase in power. This may be especially useful when accelerating from a stop, or when accelerating uphill. In such, the on-demand increase in power preserves the stored power within the semi-truck's main battery or batteries, extending the range it is capable of travelling between charges. The additional power may also be useful when transporting heavy loads which require additional power to move efficiently and effectively.

Alternatively, the auxiliary power system may be used to significantly increase the range of the semi-truck while hauling the semi-trailer. This configuration allows for the semi-truck to haul over longer distances between charges, thus reducing the time to delivery for the load it is hauling.

The system may include allow the operator to select between various operation modes including the range extending mode, power-boost mode. The range extending mode is configured to supply power to the truck battery to extend the vehicle's travel distance between charging stops. The power-boost mode provides additional power to enhance vehicle acceleration and performance, particularly for uphill driving or high-load conditions.

The renewable energy integration mode incorporates solar panels to generate supplemental energy, reducing reliance on grid electricity. The predictive energy optimization mode employs AI-based power distribution to improve efficiency and battery longevity.

The system features modular battery configurations, a power management system (PMS), and an integrated battery management system (BMS) for optimal load balancing and efficient energy distribution.

The system may provide renewable energy harvesting capabilities through the integration of solar panels onto the exterior surfaces of the vehicle. The solar channels and solar controller provide supplemental charging to the auxiliary battery system during operation or when stationary, thereby reducing dependency on grid electricity and enhancing sustainability.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the auxiliary power system within a semi-trailer to provide auxiliary power to a semi-truck, wherein the auxiliary power system is utilized to extend the range of the semi-truck, according to some embodiments;

FIG. 2 illustrates a perspective view of a front end of the semi-trailer having the auxiliary power system mounted thereto, according to some embodiments;

FIG. 3 illustrates a perspective view of a front end of the semi-trailer having the auxiliary power system mounted thereto, according to some embodiments;

FIG. 4 illustrates a perspective view of the auxiliary power system being utilized to substantially increase the power of the semi-truck, wherein the auxiliary power system is mounted to the semi-trailer, according to some embodiments;

FIG. 5 illustrates a block diagram of the auxiliary power system infrastructure, according to some embodiments;

FIG. 6 illustrates a block diagram of the auxiliary power system power flow, according to some embodiments;

FIG. 7 illustrates a block diagram of the auxiliary power system power flow and includes an auxiliary BMS, according to some embodiments; and

FIG. 8 illustrates block diagrams of the parallel (load sharing) and direct connection modes, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an auxiliary power system which is mounted to a semi-trailer typically hauled by a semi-truck. The auxiliary power system is used to extend the range over which the truck my travel between recharging and/or to substantially increase the power output of the semi-truck. The system includes a power storage device (i.e., a battery, fuel cell, or similar power storage device known in the arts).

The system addresses fundamental limitations of electric semi-trucks by providing additional power capacity without compromising the truck's primary design or cargo capacity.

The auxiliary power system functions in various configurations, including range extension and/or performance enhancement modes. In the range extension configuration, the system significantly increases the distance an electric semi-truck can travel between charging events by supplementing the truck's main batteries with additional power stored in the auxiliary power system. In performance enhancement configuration, the system provides on-demand power boosts during high-demand operational scenarios, such as acceleration from standstill, uphill driving, or transportation of particularly heavy loads.

In some embodiments, the auxiliary power system may be utilized to substantially increase the range between recharging of the semi-trucks main battery. In this configuration, the power storage device is mounted to the semi-trailer. This may be useful for providing sustained auxiliary power throughout a long-distance haul, or to provide power to the semi-truck once its main battery has been depleted.

In some embodiments, the auxiliary power system may be mounted to most any component of the trailer including the exterior surfaces of the trailer, the interior surfaces of the trailer, the roof of the trailer, the front of the trailer, the underside of the trailer, etc.

In some embodiments, the auxiliary power system may be configured to be utilized as a means for delivery additional power to the main battery of the semi-truck in order to substantially increase the power output of the semi-trucks main battery. In such, the auxiliary power system may provide on-demand auxiliary power to the semi-truck. This may be especially useful when accelerating from a stop or when accelerating uphill.

While using range extension mode, the auxiliary power system 100 the system prioritizes supplementing the truck's main batteries to maximize the distance traveled between charging events. Power distribution is optimized to maintain consistent energy availability throughout the vehicle's route, reducing the need for frequent recharging stops and improving operational efficiency.

While using power-boost mode, the system is configured to provide supplemental and on-demand power during high-demand operational scenarios, such as while accelerating, during uphill driving, or during heavy load transport.

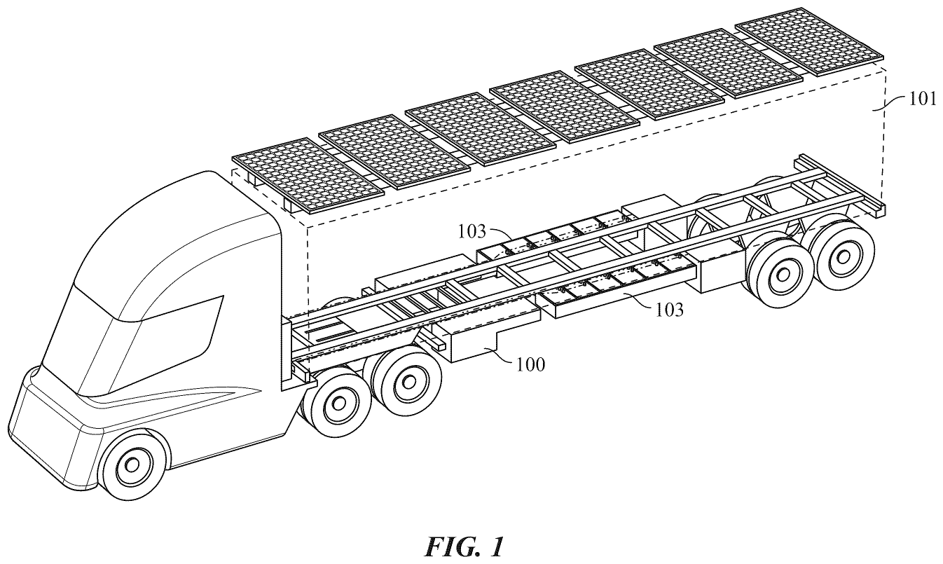

FIGS. 1-3 illustrate the auxiliary power system 100 within a semi-trailer 101 to provide auxiliary power to a semi-truck (not shown). In the illustrated embodiments, the auxiliary power system 100 is configured to be utilized to extend the range of the semi-truck. The auxiliary power system 100 includes a power storage device 103 mounted to the interior of the semi-trailer 101.

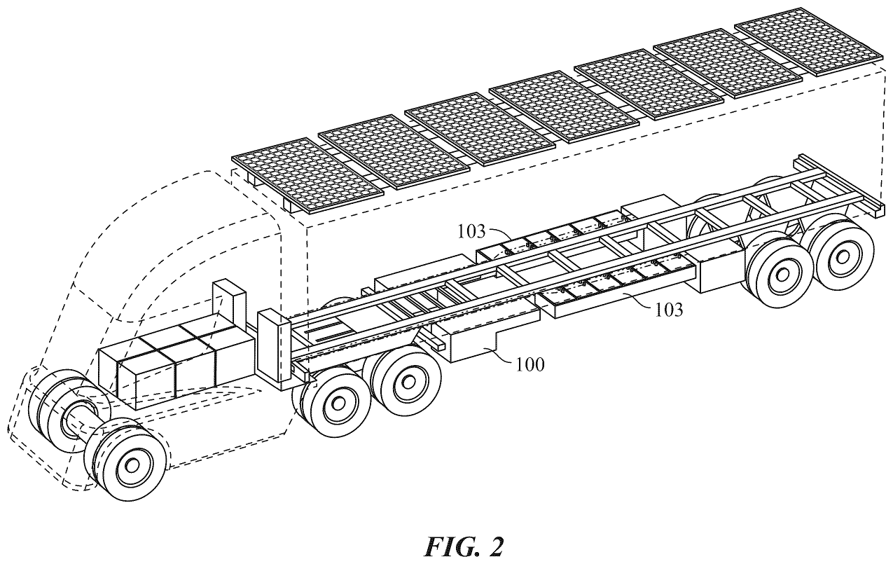

FIG. 2 illustrates the semi-trailer 101 with an auxiliary power system 100 installed on the frame (or other structure) of the semi-trailer 101. This configuration optimizes space utilization while protecting the power storage components from external environmental factors.

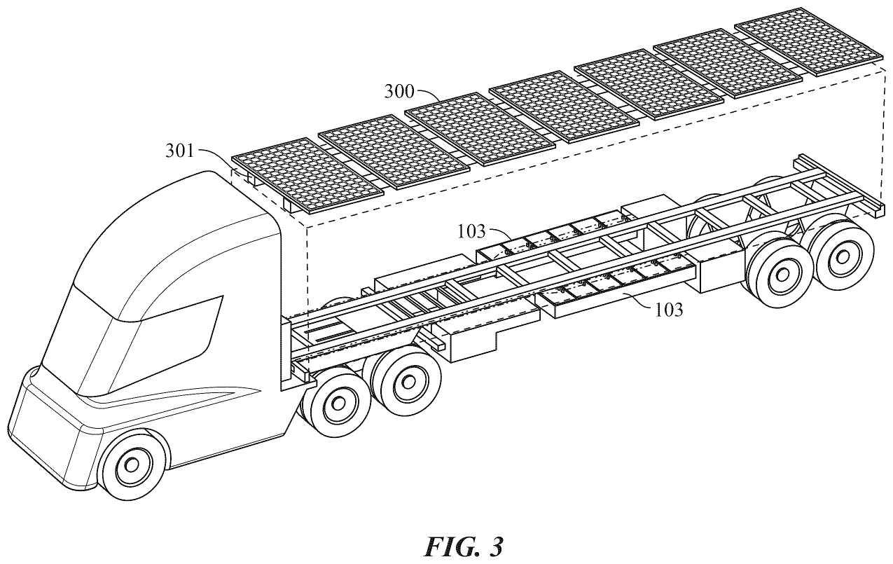

In specific reference to FIG. 3, the semi-trailer 101 may include one or more solar cells 300. The solar cells 300 are in electrical communication with the power storage device 103. The solar cells 300 are positioned on the top 301 of the semi-trailer 101 to convert light from the sun into electricity which is stored by the power storage device 103. Mounting the solar cells 300 to the top 301 of the semi-trailer 101 advantageously orients the solar cells 300 to capture the most possible sunlight while driving or while parked.

In some embodiments, the solar cells 300 may be mounted to any exterior surface of the trailer including the sides, front, and rear surfaces to optimize power output of the solar cells 300.

In some embodiments, the solar cells 300 may transmit electricity to the power storage device 103 in real-time while the vehicle is parked and/or while in motion.

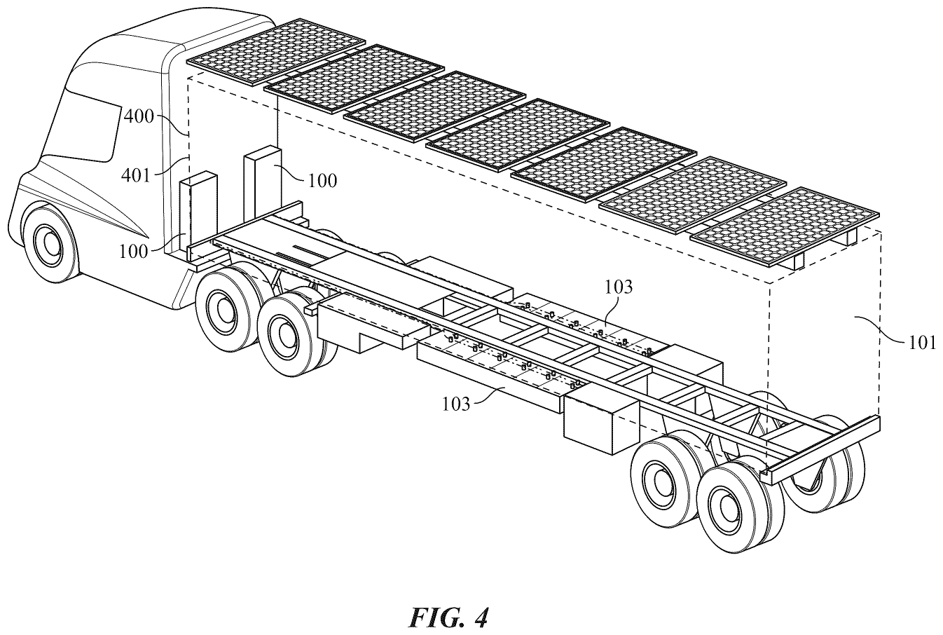

FIG. 4 illustrates the auxiliary power system 100 being utilized to substantially increase the power output of the semi-truck. In this embodiment, the auxiliary power system 100 is mounted to the exterior 400 of the front end 401 of the semi-trailer 101.

In some embodiments, the auxiliary power system 100 is removable from the semi-trailer 101. This may allow an operator to remove and transport the auxiliary power system to another vehicle as needed.

In some embodiments, the auxiliary power system 100 is rechargeable. Recharging of the auxiliary power system may occur in tandem with charging the main battery of the semi-truck or may be performed separately from the charging of the main battery of the semi-truck. The auxiliary power input may include a charge port similar to known charging ports commonly utilized to recharge electric vehicles.

To provide auxiliary power to the semi-truck, the truck is connected to the semi-trailer and an electrical connection is made between the main battery (or batteries) of the semi-truck to the auxiliary power system 100. The controller may aid in the selective operation of various functionalities of the system including for example, load balancing. This provides the operator with the ability to conserve or utilize power stored in the power storage device as needed.

In some embodiments, the auxiliary power system 100 may include a controller to allow the operator of the semi-truck to control power output from the power storage device 103. The controller may be in communication with a user interface to allow the operator to select from various operational settings (e.g., power output).

In some embodiments, the controller is in operable communication with a manual or automatic switch to allow the operator and/or system to control the power output of the auxiliary power system 100. In this embodiment, the operator can manually select between an ON/OFF function to supply or turn off the on-demand auxiliary power delivery system.

In some embodiments, the controller is in operable communication with an automatic switch which allows for the automated delivery of power from the auxiliary power system. In this embodiment, the controller operates the automatic switch using information received from an electronic board which analyzes the truck's main battery level to determine if auxiliary power from the auxiliary power system 100 is beneficial to the truck's performance.

In some embodiments, the auxiliary power system 100 may be used as a portable charger to charge the truck's main battery. This embodiment may be especially useful for supplying additional power to the main battery if charging stations are not available. Further, this allows the truck to recharge in remote locations where traditional energy grid-based recharging stations are not available.

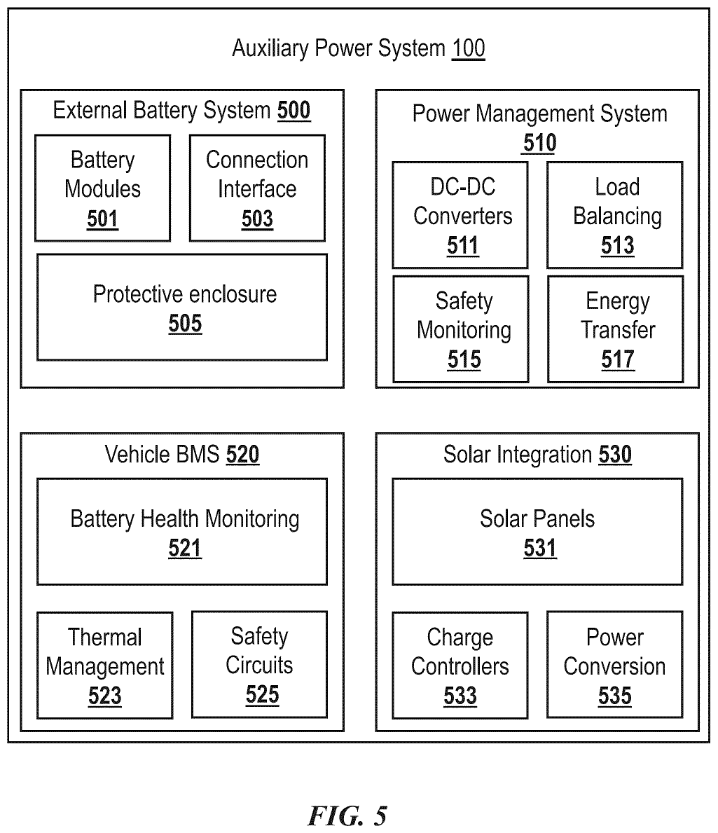

FIG. 5 illustrates a block diagram of the auxiliary power system 100 infrastructure including an auxiliary battery system 500, a power management system 510, a vehicle BMS 520, and a solar integration system 530. The auxiliary battery system 500 is comprised of a battery modules 501 and a connection interface 503 provided within a protective enclosure 505. The power management system (PMS) 510 includes DC-DC converters 511, load balancing 513, a safety monitoring system 515 and an energy transfer system 517. The vehicle BMS 520 includes a battery health monitor 521, thermal management system 523, and safety circuits 525. The Solar integration system 530 includes solar panels 531, charge controllers 533, and power conversion means 535.

The auxiliary battery system 500 includes modular high-capacity battery packs 501 designed for both rapid charging and swapping, a standardized connection interface 503 that facilitates quick disconnection and reconnection, and a protective enclosure 505 designed for rapid deployment. The battery modules 501 may comprise high-capacity lithium-ion cells, solid-state batteries, or graphene-based ultracapacitors, depending on the specific implementation requirements. The swappable nature of the battery modules enables depleted units to be quickly exchanged with fully charged ones at designated swapping stations, virtually eliminating downtime associated with recharging.

The power management system (PMS) 510 functions as the central control unit managing power flow and incorporates DC-DC converters 511 for voltage regulation, load balancing components 513, a safety monitoring system 515, and an energy transfer system 517. This subsystem is responsible for ensuring safe and efficient power distribution between the auxiliary battery system 500 and the truck's main batteries.

The vehicle battery management system (BMS) 520 includes components for battery health monitoring 521, thermal management 523 for regulating operating temperature, and safety circuits 525. The BMS 520 continuously evaluates the charge levels, battery degradation, and overall health of both the external and onboard battery systems to ensure optimal operation and longevity.

The solar integration system 530 comprises solar panels 531 mounted on the truck roof or trailer, charge controllers 533, and power conversion means 535. This subsystem functions as an independent power source that harvests renewable energy to supply power to the 500 auxiliary battery system, without being structurally integrated into the modular battery components themselves. The solar system reduces dependence on grid electricity, generates supplemental energy during operation, and continues to charge the auxiliary battery even when the vehicle is parked.

The auxiliary battery is a modular energy storage solution designed to be housed within or mounted auxiliary on a semi-trailer. This system provides additional power to supplement the truck's primary battery, thereby increasing the vehicle's range and optimizing energy consumption.

The auxiliary battery system comprises one or more high-capacity lithium-ion battery packs. Alternative embodiments may include solid-state batteries or graphene-based ultracapacitors to enhance energy density and charge-discharge efficiency.

The auxiliary battery system is securely mounted to the trailer using reinforced brackets and shock-absorbing materials to minimize vibrations and mechanical stress. It is connected to the truck's powertrain via a bidirectional power transfer system, which allows seamless energy exchange between the auxiliary battery and the truck's main power source.

The auxiliary battery system is integrated with multiple safety features, including thermal monitoring sensors, overvoltage protection, short-circuit prevention circuits, and an emergency disconnection mechanism.

The system supports multiple charging methods, including direct grid charging, regenerative braking energy recovery, and solar energy harvesting through the solar integration system.

The power management system is responsible for regulating energy distribution between the truck's main battery, the auxiliary battery system, and renewable energy inputs. This intelligent system ensures optimal power utilization while preventing battery degradation and energy losses. The power management system provides dynamic load balancing and continuously monitors power demand and dynamically allocates energy from the auxiliary battery system or solar integration system based on driving conditions, acceleration, and load requirements. Utilizing advanced microcontrollers and artificial intelligence (AI) algorithms, the PMS predicts energy requirements and optimizes power flow to maintain peak vehicle performance.

The power management system provides adaptive energy prioritization such that energy from the auxiliary battery is reserved for future use in the case wherein the vehicle battery is charged to a threshold level. If the vehicle battery drops below a threshold level, the auxiliary battery system prioritizes charging the truck's battery to extend range. During high-load conditions, the system may temporarily redirect additional power to the truck's propulsion system. The system may operate using a Controller Area Network (CAN) or Modbus communication protocol, enabling real-time data exchange between the truck, the auxiliary battery system, and the vehicle's BMS.

The vehicle battery management system (BMS) oversees the truck's main battery and auxiliary power system, ensuring safe and efficient operation. The BMS continuously evaluates the charge levels, battery degradation, and overall health of both the truck's main battery and the auxiliary battery system. Equipped with liquid cooling modules and thermal insulation, the BMS actively regulates temperature to prevent overheating, improving battery lifespan and efficiency.

The BMS communicates with the PMS to ensure seamless integration between the truck's propulsion system and the auxiliary battery. It also prevents deep discharge and overcharging by adjusting charge rates dynamically.

In some embodiments, the BMS logs performance data and alerts the driver or fleet operator regarding potential battery issues. AI-driven predictive maintenance reduces downtime by forecasting potential failures before they occur.

The solar integration system provides a renewable energy source to extend the vehicle's operational range and reduce dependency on auxiliary charging infrastructure. High-efficiency solar panels are mounted on the roof of the semi-trailer to capture maximum sunlight exposure. Some embodiments may include retractable or tilting solar panels to optimize energy capture throughout the day.

A charge controller optimizes power conversion efficiency, ensuring that maximum solar energy is stored in the auxiliary battery system.

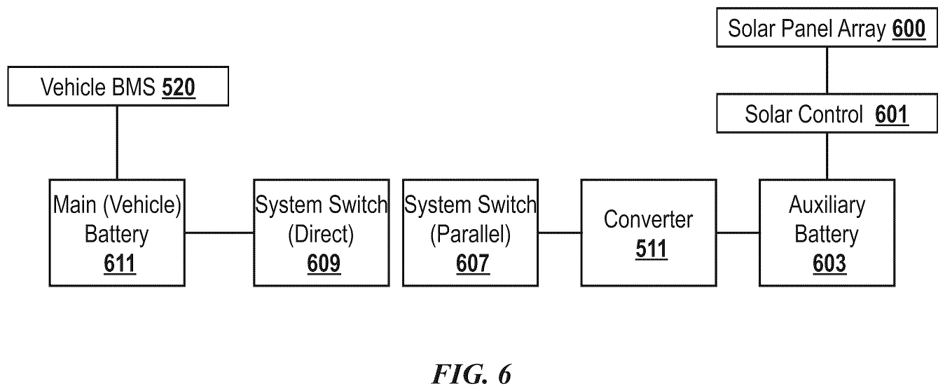

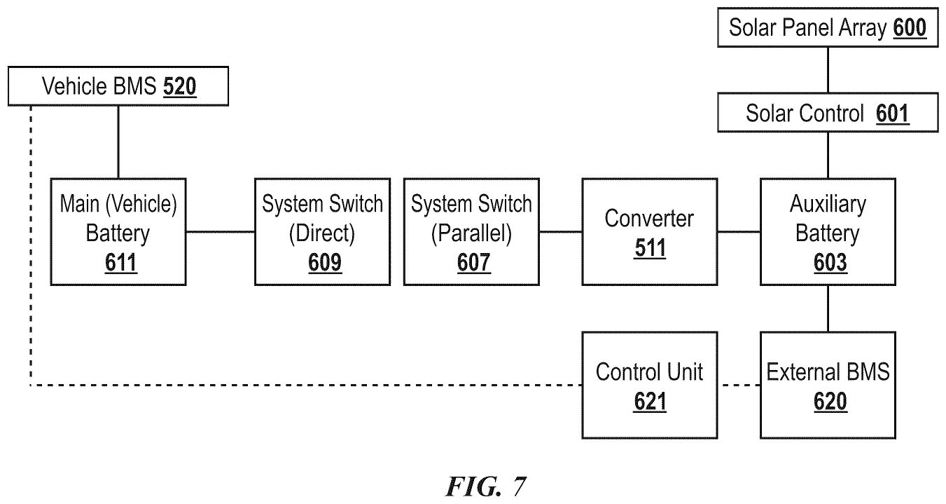

FIG. 6 and FIG. 7 illustrate block diagrams of the auxiliary power system power flow. In specific reference to FIG. 7, the system is shown including an auxiliary BMS 620 and control unit 621. The solar panel array 600 provides power to the solar controller 601 which transmits power to the auxiliary battery 603. In either embodiment, once the auxiliary battery 603 receives power it is transmitted to the converter 511 which and switch mechanism which allows the user to select between a parallel 607 or direct switch 609. Power is then transmitted to the main (vehicle) battery 611 operated by the vehicle BMS 520.

Power from the auxiliary battery 603 is transmitted through a converter 511 and switch mechanism, which allows selection between parallel 607 or direct 609 connection modes before supplying power to the main vehicle battery 611.

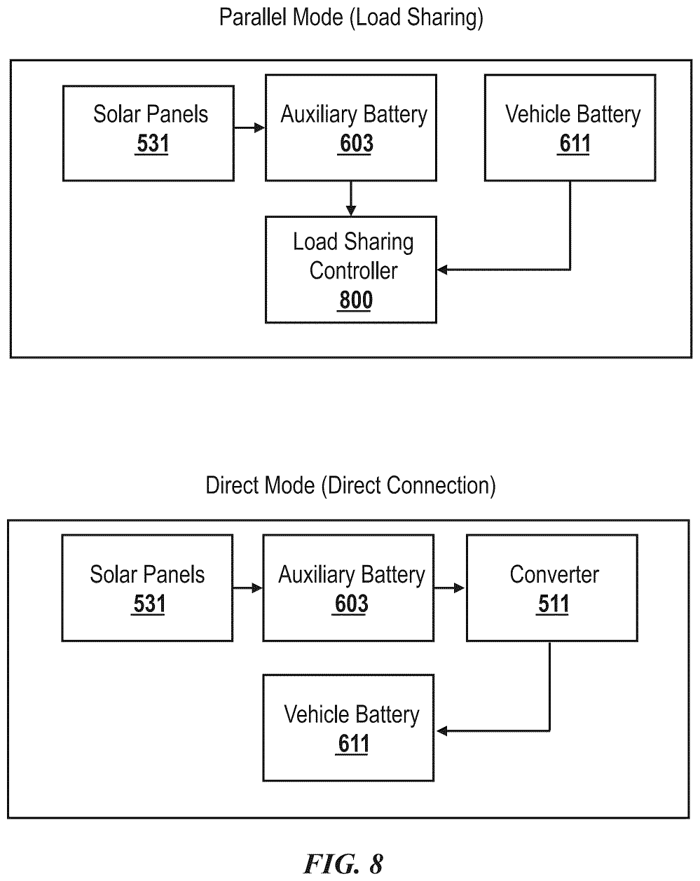

FIG. 8 illustrates block diagrams of the parallel (load sharing) and direct connection modes. In the parallel mode, both the auxiliary battery 603 and vehicle battery 611 power the vehicle and are connected to a load sharing controller 800 and receive power from the solar panels 531. The controller dynamically balances power draw from both sources based on demand and conditions. The solar panels 531 generate supplementary power that charges the auxiliary battery. This mode provides redundancy and optimal power distribution during high-demand situations. The direct connection mode creates a more straightforward power path primarily for charging and steady-state operation. The auxiliary battery 603 connects to the vehicle battery 611 through a DC/DC converter 511 which manages voltage matching between the batteries. This mode is more efficient for steady-state operation and charging.

In some embodiments, the parallel integration mode enables both the auxiliary battery 603 and the vehicle battery 611 to simultaneously power the vehicle through a load-sharing controller 800. This controller dynamically balances power draw between the two sources based on operational demands and conditions. The parallel integration provides increased operational redundancy-if one battery fails, the other still provides power—and extends battery lifespan due to reduced stress on individual units.

The direction connection mode establishes a more straightforward power path, primarily for charging and steady-state operation, wherein the auxiliary battery 603 connects to the vehicle battery 611 through a DC/DC converter 511 that manages voltage matching between the battery systems. This mode offers simpler implementation with fewer control algorithms and more efficient energy transfer with minimal power conversion losses.

The power management system is responsible for regulating energy distribution between the truck's main battery, the auxiliary battery system, and renewable energy inputs. This intelligent system ensures optimal power utilization while preventing battery degradation and energy losses. The power management system provides dynamic load balancing and continuously monitors power demand and dynamically allocates energy from the auxiliary battery system. Utilizing advanced microcontrollers and artificial intelligence (AI) algorithms, the PMS predicts energy requirements and optimizes power flow to maintain peak vehicle performance.

In some embodiments, the auxiliary battery 603 may be provided as a rapid swap battery system which enables electric semi-trucks to replace depleted battery packs with fully charged units within minutes, significantly reducing downtime compared to traditional charging methods. The rapid swap battery system employs a modular battery pack design, allowing battery units to be easily removed and replaced using standardized mounting and connection mechanisms, ensuring compatibility across different truck models. Battery swap stations are strategically located along major transportation routes, logistics hubs, and distribution centers, providing convenient access for truck operators to quickly exchange depleted batteries. These stations can be equipped with automated or semi-automated swapping mechanisms, including robotic arms, conveyor-based handling systems, or guided track installations that facilitate efficient battery replacement.

In some embodiments, the system supports optimized battery lifecycle management, allowing batteries to be recharged under controlled conditions at dedicated facilities, extending their lifespan and improving reliability. Swapping stations can be designed for scalability, with modular setups that accommodate multiple vehicles simultaneously, ensuring seamless operations even during peak demand periods. Energy storage and grid integration can also be incorporated into the swapping stations, enabling surplus power to be stored or fed back into the grid during off-peak hours. By eliminating the primary challenge of charging delays, the rapid battery swap system makes electric freight transportation more practical, cost-effective, and viable for long-haul trucking applications.

In some embodiments, the load-sharing controller utilizes adaptive power distribution algorithms that analyze energy consumption patterns and efficiently allocate power from the auxiliary battery to supplement the vehicle's main battery. This results in a seamless transition between energy sources without disrupting vehicle performance.

A key advantage of parallel integration is redundancy, ensuring that if one power source experiences a failure or reduced efficiency, the other can compensate, preventing operational downtime. This enhances the reliability of electric semi-trucks, especially for long-haul applications. Another major benefit is extended battery lifespan—by distributing energy demands between the auxiliary and main battery packs, stress on individual cells is reduced, leading to lower degradation rates and longer operational life for both battery systems.

In some embodiments, the direct connection operation relies on a voltage-matching and regulation system that ensures the auxiliary battery seamlessly transfers power to the truck's main battery without overloading or damaging sensitive electrical components. The direct connection system features DC/DC converters that adjust voltage levels dynamically, preventing mismatches that could lead to inefficiencies, overheating, or power loss during energy transfer. This method provides a simplified power path, reducing energy conversion steps and thereby minimizing energy losses, making it particularly efficient for steady-state operations such as highway driving, where power demands are more predictable. Efficiency benefits of direct charging include reduced heat generation, minimized conversion losses, and improved charge acceptance rates by ensuring that the main battery receives power in an optimized voltage and current range. In scenarios where a truck is at a rest stop or depot, the direct connection approach enables efficient and uninterrupted energy transfer, quickly replenishing the main battery without requiring a complex load-balancing system.

Both integration methods can be further optimized with machine learning-driven energy management, allowing predictive adjustments based on historical power consumption data, traffic patterns, and route conditions to further enhance efficiency and reliability.

In some embodiments, the power management system (PMS) conducts a series of system checks to verify the operational status of all components, including battery charge levels, voltage stability, and connection integrity between the truck's main battery and the auxiliary battery system. The PMS establishes communication with both the auxiliary battery system and the truck's Battery Management System (BMS) using a CAN bus or Modbus protocol, ensuring real-time data exchange.

A voltage matching and synchronization process is executed to equalize the voltage levels between the auxiliary battery, truck's battery, and renewable energy sources, preventing current spikes or irregular charging patterns. The PMS verifies temperature levels, internal resistance, and state-of-charge (SOC) consistency before allowing energy transfer, ensuring safe and optimized power distribution.

If any anomalies are detected, diagnostic alerts are generated, and the system may delay or modify energy transfer to protect the batteries from damage.

In some embodiments, the PMS continuously monitors power demand by analyzing vehicle acceleration, load weight, terrain, and battery state-of-health (SOH) in real-time. A dynamic load-balancing algorithm distributes power between the auxiliary battery, truck's onboard battery, and renewable sources (e.g., solar panels) to optimize performance and reduce strain on any single power source. The charging/discharging cycles for both battery systems are managed through a predictive AI-based energy management model, which ensures efficient energy use based on expected driving patterns. The PMS can adapt energy flow based on different operational states, such as prioritizing direct charging from the auxiliary battery during peak demand or engaging regenerative braking energy recovery when the truck is decelerating. A fail-safe mode prevents deep discharge by restricting power draw when the auxiliary battery reaches critical levels, ensuring that the truck's primary battery remains the primary energy source in emergencies.

In some embodiments, the safety monitoring system provides continuous parameter monitoring ensures safe operation by tracking temperature, voltage, and current levels across all battery systems. Regulation mechanisms include active thermal management, such as liquid cooling or fan-assisted air cooling, to maintain optimal battery temperature during high-load conditions. The fault detection system uses real-time diagnostics to identify potential risks, including overcharging, short circuits, or excessive heat generation. Emergency disconnection features include an automated cutoff relay that isolates the auxiliary battery from the truck's main power system in case of voltage fluctuations, extreme overheating, or internal system faults. A redundancy safety layer ensures that if one monitoring system fails, an auxiliary safety mechanism takes over, preventing potential hazards and ensuring safe energy transfer.

Swappable auxiliary battery units can be used to integrate with the system rather than using a fixed auxiliary battery pack, modular quick-swap battery units can be implemented, allowing truck operators to replace a depleted battery with a fully charged one at designated swap stations.

Wireless charging coupling can be used including inductive or resonant wireless charging systems which allow for energy transfer between the auxiliary battery and truck without physical connectors, reducing wear and improving reliability in harsh environments.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An auxiliary power system for an electric semi-truck, comprising:
a power storage device mounted to a semi-trailer; and
one or more main batteries to provide propulsion to a semi-truck, the one or more main batteries in electrical communication with the power storage device to receive auxiliary power therefrom,
wherein the power storage device is operable to increase the range over which the semi-truck travels between recharging.

2. The auxiliary power system of claim 1, further comprising one or more solar cells mounted to a top of the semi-trailer, the one or more solar cells to recharge the power storage device.

3. The auxiliary power system of claim 1, further comprising a controller to provide the on-demand modulation of the power output of the power storage device, wherein the controller is operable to increase an operational range and on-demand power output.

4. The auxiliary power system of claim 3, further comprising a load distributor in operable communication with the controller to allow for the on-demand control of load distribution throughout the auxiliary power system.

5. The auxiliary power system of claim 4, wherein the controller is in operable communication with a manual or an automated switch.

6. The auxiliary power system of claim 1, wherein the power storage device is removable from the semi-trailer.

7. An auxiliary power system for an electric semi-truck, comprising:
a power storage device mounted to a front end of an exterior of a semi-trailer;
one or more main batteries to provide propulsion to a semi-truck, the one or more main batteries in electrical communication with the power storage device to receive auxiliary power therefrom; and
a controller to selectively distribute power from the power storage device to the one or more main batteries;
wherein the power storage device is operable to provide the on-demand increase to the power output capacity of the semi-truck.

8. The auxiliary power system of claim 7, further comprising one or more solar cells mounted to a top of the semi-trailer, the one or more solar cells to recharge the power storage device.

9. The auxiliary power system of claim 8, further comprising a load distributor in operable communication with the controller to allow for the on-demand control of load distribution throughout the auxiliary power system.

10. The auxiliary power system of claim 9, wherein the controller is in operable communication with a manual or an automated switch to enable selection of a range extension mode and a power boost mode.

11. The auxiliary power system of claim 7, wherein the power storage device is removable from the exterior of the semi-trailer.

12. An auxiliary power system for an electric semi-truck, comprising:
a power storage device mounted to a front end of an exterior of a semi-trailer;
one or more main batteries to provide power to a semi-truck drive system, the one or more main batteries in electrical communication with the power storage device to receive auxiliary power therefrom;
a load-balancing controller configured to optimize power distribution between the one or more main batteries and an auxiliary power storage device; and
a solar integration module connected to one or more solar panels positioned on the semi-trailer,
wherein the power storage device is operable to provide the on-demand increase to the power output capacity of the semi-truck.

13. The auxiliary power system of claim 12, wherein the load-balancing controller is configured to adjust power distribution using real-time vehicle acceleration and deceleration data.

14. The auxiliary power system of claim 13, further comprising a battery monitoring system to provide predictive load-balancing.

15. The auxiliary power system of claim 14, wherein the battery monitoring system includes a thermal management system configured to prevent overheating of the auxiliary power storage device and the one or more main batteries.

16. The auxiliary power system of claim 15, wherein the battery monitoring system includes an emergency disconnect in operable communication with a safety monitoring system.

17. The auxiliary power system of claim 12, further comprising a protective enclosure to enclose the auxiliary power system.

18. The auxiliary power system of claim 12, further comprising a load distributor in operable communication with the load-balancing controller to allow for the on-demand control of load distribution throughout the auxiliary power system.

19. The auxiliary power system of claim 13, wherein the controller is in operable communication with a manual or an automated switch.

20. The auxiliary power system of claim 12, wherein the auxiliary power system is configured to enable regenerative braking energy recovery.
